(19) United States
(12) Patent Application Publication
(10) Pub. No.: US 2008/0032123 A1
(43) Pub. Date: Feb. 7, 2008

(54) DUAL ELECTRON-TRANSPORTING LAYER FOR OLED DEVICE

(76) Inventors: Jeffrey P. Spindler, Rochester, NY (US); Tukaram K. Hatwar, Penfield, NY (US); William J. Begley, Webster, NY (US); Tommie L. Royster, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 11/461,821

(22) Filed: Aug. 2, 2006

(51) Int. Cl. B32B 9/00

(52) U.S. Cl. 428/336; 428/411.1

(57) ABSTRACT

An OLED device including spaced anode and cathodes; at least one light-emitting layer, and a hole-transporting layer disposed between the anode and the light-emitting layer; and a first electron-transporting layer in contact with at least one light-emitting layer and a second electron-transporting layer in contact with the first electron-transporting layer, wherein the first and second electron-transporting layers are disposed between the at least one light-emitting layer and the cathode, wherein: the first electron-transporting layer contains an anthracene compound; and the second electron-transporting layer contains an anthracene compound and at least one salt or complex of an element selected from Group 1, 2, 12 or 13 of the Periodic Table, and is further doped with an alkali metal.

### CROSS REFERENCE TO RELATED APPLICATIONS

Reference is made to commonly assigned U.S. patent application Ser. No. 11/393,767 filed Mar. 20, 2006, entitled “Efficient White-Light OLED Display with Filters” by Hatwar et al.; U.S. patent application Ser. No. 11/258,671, filed Oct. 26, 2005, entitled “Organic Element for Low Voltage Electroluminescent Devices” by Begley et al; U.S. patent application Ser. No. 11/170,681 filed Jun. 29, 2005, entitled “White Light Tandem OLED Display With Filters” by Hatwar et al., the disclosures of which are incorporated herein by reference.

### FIELD OF THE INVENTION

The present invention relates to a white OLED device with good luminance and reduced drive voltage.

### BACKGROUND OF THE INVENTION

While organic electroluminescent (EL) devices have been known for over two decades, their performance limitations have represented a barrier to many desirable applications. In simplest form, an organic EL device is comprised of an anode for hole injection, a cathode for electron injection, and an organic medium sandwiched between these electrodes to support charge recombination that yields emission of light. These devices are also commonly referred to as organic light-emitting diodes, or OLEDs. Representative of earlier organic EL devices are Gurnee et al. U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, 30, 322, (1969); and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often greater than 100V.

More recent organic EL devices include an organic EL element consisting of extremely thin layers (e.g. <1.0 μm) between the anode and the cathode. Herein, the term “organic EL element” encompasses the layers between the anode and cathode. Reducing the thickness lowered the resistance of the organic layers and has enabled devices that operate at much lower voltage. In a basic two-layer EL device structure, described first in U.S. Pat. No. 4,356,429, one organic layer of the EL element adjacent to the anode is specifically chosen to transport holes, and therefore is referred to as the hole-transporting layer, and the other organic layer is specifically chosen to transport electrons and is referred to as the electron-transporting layer. Recombination of the injected holes and electrons within the organic EL element results in efficient electroluminescence. There have also been proposed three-layer organic EL devices that contain an organic light-emitting layer (LEL) between the hole-transporting layer and electron-transporting layer, such as that disclosed by C. Tang et al. (J. Applied Physics, Vol. 65, 3610 (1989)), and in U.S. Pat. No. 4,769,292 a four-layer EL element comprising a hole injecting layer (HIL), a hole-transporting layer (HTL), a light-emitting layer (LEL) and an electron-transporting/injecting layer (ETL). These structures have resulted in improved device efficiency.

Since these early inventions, further improvements in device materials have resulted in improved performance in attributes such as color, stability, luminance efficiency and manufacturability, e.g., as disclosed in U.S. Pat. Nos. 5,061,569; 5,409,783; 5,554,450; ;5,593,788; 5,683,823; 5,908,581; 5,928,802; 6,020,078 and 6,208,077, amongst others. For example, a useful class of electron-transporting materials is that derived from metal-chelated oxinoid compounds including chelates of oxine itself, also commonly referred to as 8-quinolinol or 8-hydroxyquinoline. Tris(8-quinolinolato)aluminum (III), also known as Alq or Alq₃, and other metal and non-metal oxine chelates are well known in the art as electron-transporting materials. Tang et al., in U.S. Pat. No. 4,769,292 and VanSlyke et al., in U.S. Pat. No. 4,539,507 teach lowering the drive voltage of the EL devices by the use of Alq as an electron-transporting material in the luminescent layer or luminescent zone.

Baldo et al., in U.S. Pat. No. 6,097,147 and Hung et al., in U.S. Pat. No. 6,172,459 teach the use of an organic electron-transporting layer adjacent to the cathode so that when electrons are injected from the cathode into the electron-transporting layer, the electrons traverse both the electron-transporting layer and the light-emitting layer.

The use of a mixed layer of a hole-transporting material and an electron-transporting material in the light-emitting layer is well known. For example, see U.S. Patent Application Publication 2004/0229081; U.S. Pat. Nos. 6,759,146; 6,759,146; 6,753,098 and 6,713,192 and references cited therein. Kwong et al., U.S. Patent Application Publication 2002/0074935, describe a mixed layer comprising an organic small molecule hole-transporting material, an organic small molecule electron-transporting material and a phosphorescent dopant.

Tamano et al., in U.S. Pat. No. 6,150,042, teach use of hole-injecting materials in an organic EL device. Examples of electron-transporting materials useful in the device are given, and included therein are mixtures of electron-transporting materials.

Seo et al., in U.S. Patent Application Publication 2002/0086180, teach the use of a 1:1 mixture of Bphen, (also known as 4,7-diphenyl-1,10-phenanthroline or bathophenanthroline) as an electron-transporting material, and Alq as an electron-injecting material, to form an electron-transporting mixed layer. However, the Bphen/Alq mix of Seo et al. has inferior stability.

U.S. Patent Application Publication 2004/0207318 and U.S. Pat. No. 6,396,209 describe an OLED structure including a mixed layer of an electron-transporting organic compound and an organic metal complex compound containing at least one of alkali metal ion, alkaline earth metal ion, or rare earth metal ion.

JP 2000/053957 teaches the use of photogenes and WO 9963023 teaches the use of organometallic complexes useful in the luminescent layer or the electron-injecting/transporting layers.

U.S. Patent Application Publication 2004/0067387 teaches the use of one or more compounds of an anthracene structure in the electron-transporting/electron-injecting layer(s) and one or more other compounds, including Alq₃, may be added.

U.S. Pat. No. 6,468,676 teaches the use of an organic metal salt, a halogenide, or an organic metal complex for the electron-injecting layer. The organic metal complex is selected from a list of metal complexes.

Xie et al., in Chinese Journal of Semiconductors, Vol. 21, Part 2 (2000), page 184 teaches mixtures of rubrene and phenylpyridine beryllium (BePP₂) as a yellow light-emitting layer for white OLED. Use of rubrene as a dopant necessitates the rubrene to be present in 2-3% by volume.

Organometallic complexes, such as lithium quinolate (also known as lithium 8-hydroxyquinolate, lithium 8-quinolate, 8-quinolinolatolithium, or Liq) have been used in EL devices, for example see WO 0032717 and U.S. Patent Application Publication 2005/0106412. In particular, mixtures of lithium quinolate and Alq have been described as useful, for example see U.S. Pat. No. 6,396,209 and U.S. Patent Application Publication 2004/0207318.

However, these devices do not have all desired EL characteristics in terms of high luminance in combination with low drive voltages. Thus, notwithstanding these developments, there remains a need to reduce drive voltage of OLED devices while maintaining good luminance and luminance stability.

### SUMMARY OF THE INVENTION

It is therefore an object of the present invention to provide a white-light-emitting OLED device with good luminance and reduced drive voltage.

This object is achieved by an OLED device comprising:

(a) an anode and a cathode spaced apart; and

(b) at least one light-emitting layer, and a hole-transporting layer disposed between the anode and the light-emitting layer; and

(c) a first electron-transporting layer in contact with at least one light-emitting layer and a second electron-transporting layer in contact with the first electron-transporting layer, wherein the first and second layers are disposed between the at least one light-emitting layer and the cathode, wherein:
(i) the first electron-transporting layer contains an anthracene compound of Formula (1);

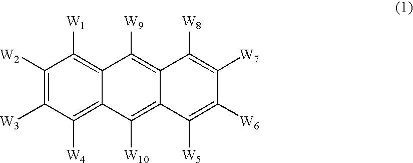

wherein W₁-W₁₀ independently represent hydrogen or an independently selected substituent, and
(ii) the second electron-transporting layer contains an anthracene compound of Formula (1) and at least one salt or complex of an element selected from Group 1, 2, 12 or 13 of the Periodic Table, and is further doped with an alkali metal.

It is an advantage of this invention that it can produce an OLED device with improved efficiency and stability. It is a further advantage of this invention that it can reduce the voltage requirements of an OLED device.

### BRIEF DESCRIPTION OF THE DRAWINGS

FIG. 1 shows a cross-sectional view of one embodiment of an OLED device in accordance with this invention;

FIG. 2 shows a cross-sectional view of another embodiment of an OLED device in accordance with this invention; and

FIG. 3 shows a cross-sectional view of another embodiment of an OLED device in accordance with this invention.

Since device feature dimensions such as layer thicknesses are frequently in sub-micrometer ranges, the drawings are scaled for ease of visualization rather than dimensional accuracy.

### DETAILED DESCRIPTION OF THE INVENTION

The term “OLED device” is used in its art-recognized meaning of a display device comprising organic light-emitting diodes as pixels. It can mean a device having a single pixel. The term “OLED display” as used herein means an OLED device comprising a plurality of pixels, which can be of different colors. A color OLED device emits light of at least one color. The term “multicolor” is employed to describe a display panel that is capable of emitting light of a different hue in different areas. In particular, it is employed to describe a display panel that is capable of displaying images of different colors. These areas are not necessarily contiguous. The term “full color” is employed to describe multicolor display panels that are capable of emitting in the red, green, and blue regions of the visible spectrum and displaying images in any combination of hues. The red, green, and blue colors constitute the three primary colors from which all other colors can be generated by appropriate mixing. The term “hue” refers to the intensity profile of light emission within the visible spectrum, with different hues exhibiting visually discernible differences in color. The term “pixel” is employed in its art-recognized usage to designate an area of a display panel that is stimulated to emit light independently of other areas. It is recognized that in full color systems, several pixels of different colors will be used together to produce a wide range of colors, and a viewer can term such a group a single pixel. For the purposes of this discussion, such a group will be considered several different colored pixels.

In accordance with this disclosure, broadband emission is light that has significant components in multiple portions of the visible spectrum, for example, blue and green. Broadband emission can also include light being emitted in the red, green, and blue portions of the spectrum in order to produce white light. White light is that light that is perceived by a user as having a white color, or light that has an emission spectrum sufficient to be used in combination with color filters to produce a practical full color display. For low power consumption, it is often advantageous for the chromaticity of the white light-emitting OLED to be close to CIE D₆₅, i.e., CIEx=0.31 and CIEy=0.33. This is particularly the case for so-called RGBW displays having red, green, blue, and white pixels. Although CIEx, CIEy coordinates of about 0.31, 0.33 are ideal in some circumstances, the actual coordinates can vary significantly and still be very useful. The term “white light-emitting” as used herein refers to a device that produces white light internally, even though part of such light can be removed by color filters before viewing.

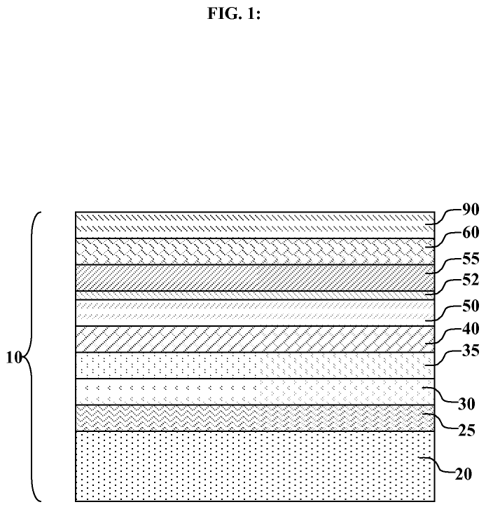

Turning now to FIG. 1, there is shown a cross-sectional view of a pixel of a light-emitting OLED device 10 according to a first embodiment of the present invention. Such an OLED device can be incorporated into e.g. a display. The OLED device 10 includes at a minimum a substrate 20, an anode 30, a cathode 90 spaced from anode 30, at least one light-emitting layer 50 provided between anode 30 and cathode 90, a hole-transporting layer 40 disposed between anode 30 and light-emitting layer 50, a first electron-transporting layer 52 in contact with the at least one light-emitting layer 50, and a second electron-transporting layer 55 in contact with first electron-transporting layer 52. The first and second electron-transporting layers 52 and 55 are disposed between light-emitting layer 50 and cathode 90.

OLED device 10 can further include other layers, e.g. hole-injecting layer 35, electron-injecting layer 60, and color filter 25. These will be described further below.

First electron-transporting layer 52 contains an anthracene compound of Formula (1);

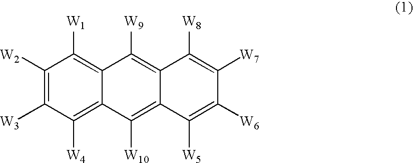

wherein W₁-W₁₀ independently represent hydrogen or an independently selected substituent. First electron-transporting layer 52 has a thickness in the range of 1 to 20 nm, and desirably in the range of 2 to 5 nm. The anthracene compound of Formula (1) comprises greater than 10% by volume of first electron-transporting layer 52. Second electron-transporting layer 55 contains an anthracene compound of Formula (1), which can be the same as or different from the anthracene compound of first electron-transporting layer 52. Second electron-transporting layer 55 has a thickness in the range of 10 to 200 nm. The anthracene compound of formula (1) includes from 10% to 90% by volume of second electron-transporting layer 55.

Second electron-transporting layer 55 further includes at least one salt or complex of an element selected from Group 1 (e.g. Li⁺, Na⁺), 2 (e.g. Mg⁺², Ca⁻²), 12 (e.g. Zn⁺²), or 13 (e.g. Al⁺³) of the Periodic Table. Desirably, the metal complex is present in the layer at a level of at least 1%, more commonly at a level of 5% or more, and frequently at a level of 10% or even 20% or greater by volume. In one embodiment, the complex is comprised of 20-60% of the layer by volume. Overall, the complex or salt can be present in the balance amount of the anthracene compound.

In some embodiments of this invention, first electron-transporting layer 52 can also include at least one salt or complex of an element selected from Group 1, 2, 12 or 13 of the Periodic Table as described above.

Second electron-transporting layer 55 is doped with an elemental metal having a work function less than 4.2 eV. The definition of work function and a list of the work functions for various metals can be found in CRC Handbook of Chemistry and Physics, 84th Edition, 2003-2004, CRC Press Inc., page 12-130. Typical examples of such metals include Li, Na, K, Be, Mg, Ca, Sr, Ba, Y, La, Sm, Gd, Yb, and is conveniently an alkali metal. In one preferred embodiment the alkali metal is Li. The elemental metal is often present in the amount of from 0.1% to 15%, commonly in the amount of 0.1% to 10%, and often in the amount of 1 to 5% by volume of the total material in the layer.

In Formula (1), W₁-W₁₀ independently represent hydrogen or an independently selected substituent, provided that two adjacent substituents can combine to form rings. Such anthracene compounds have been described by Begley et al. in U.S. patent application Ser. No. 11/393,767, the disclosure of which is herein incorporated by reference. In one embodiment of the invention W₁-W₁₀ are independently selected from hydrogen, alkyl, aromatic carbocyclic or aromatic heterocyclic groups. In another embodiment of the invention, W₉ and W₁₀ represent independently selected aromatic carbocyclic or aromatic heterocyclic groups. In yet another embodiment of the invention, W₉ and W₁₀ are independently selected from phenyl, naphthyl, biphenyl, or anthracenyl groups. For example, W₉ and W₁₀ can represent such groups as 1-naphthyl, 2-naphthyl, 4-biphenyl, 2-biphenyl, 3-biphenyl, or 9-anthracenyl. In further embodiments of the invention, W₁ - W₈ represent hydrogen, alkyl, or phenyl groups. Particularly useful embodiments of the invention are when W₉ and W₁₀ are aromatic carbocyclic groups and W₇ and W₃ are independently selected from hydrogen, alkyl or phenyl groups. Examples of useful carbocyclic aromatic fused ring compounds for the invention are as follows.

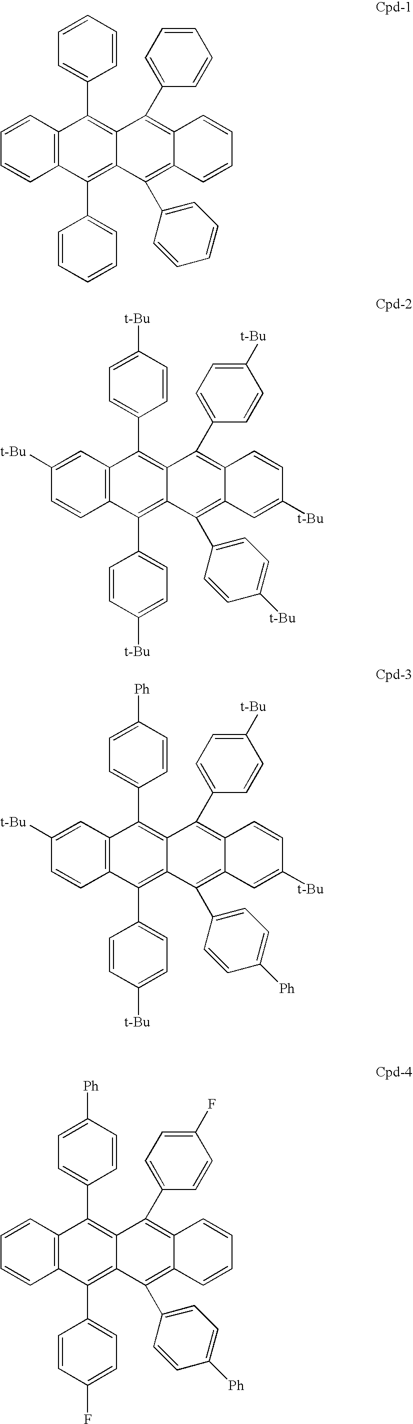

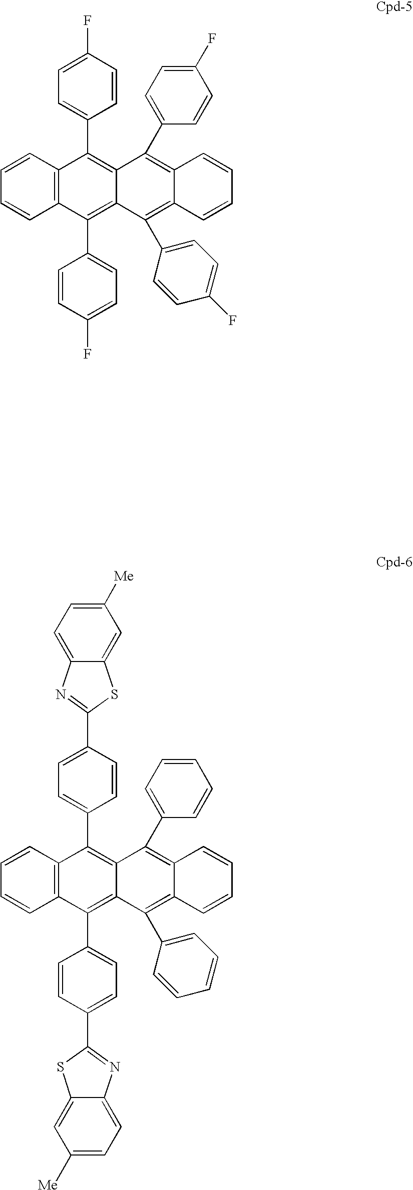

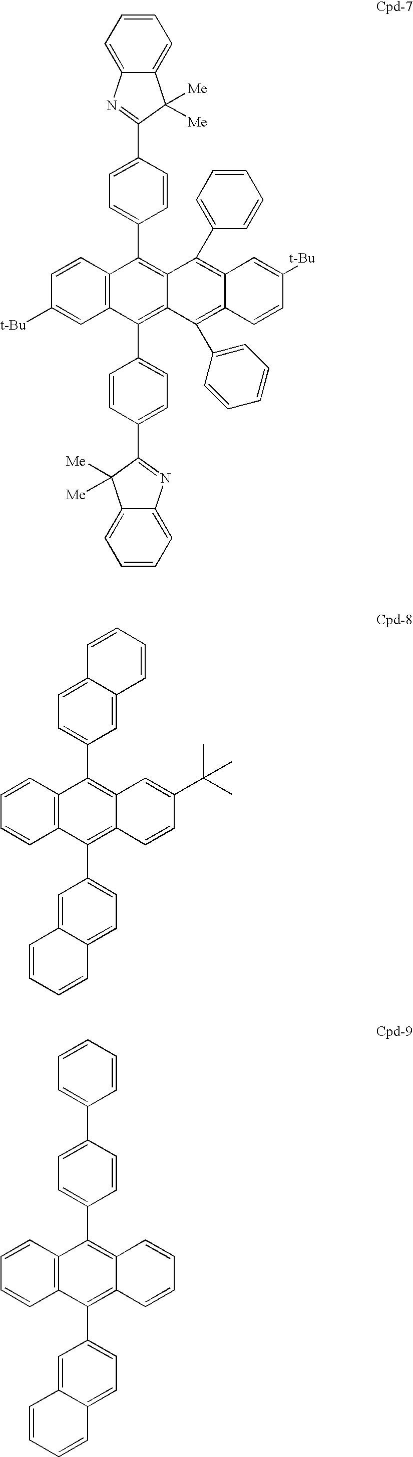

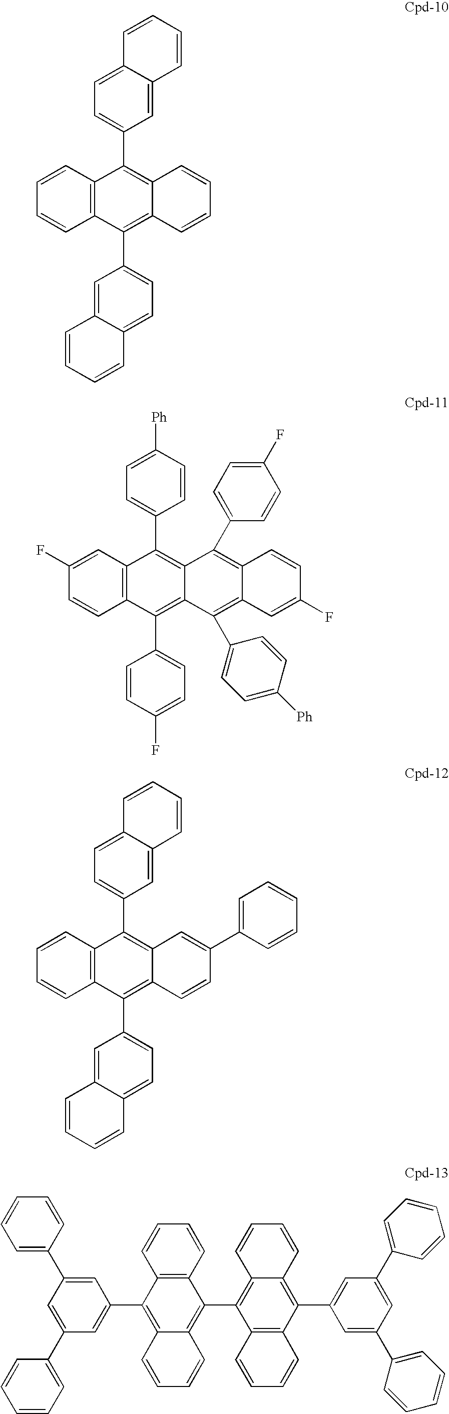

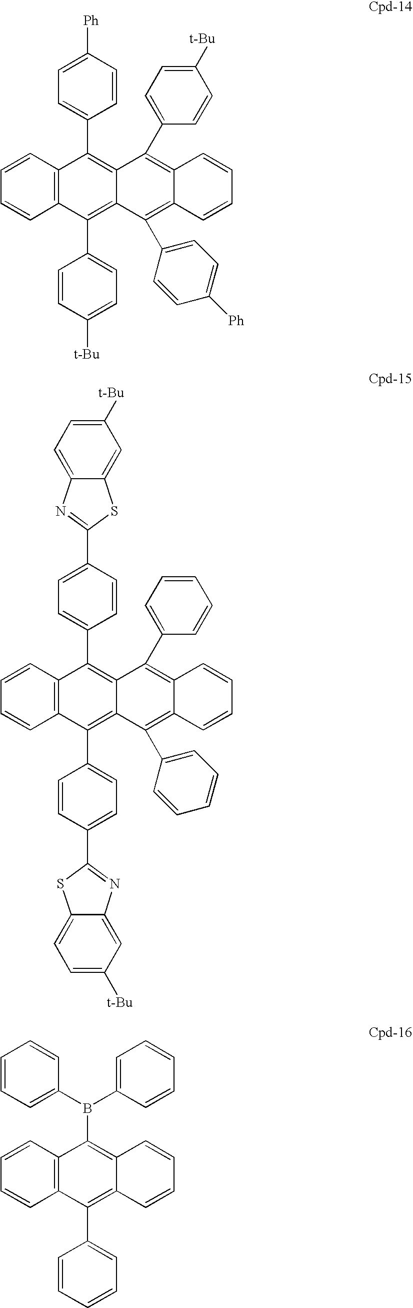

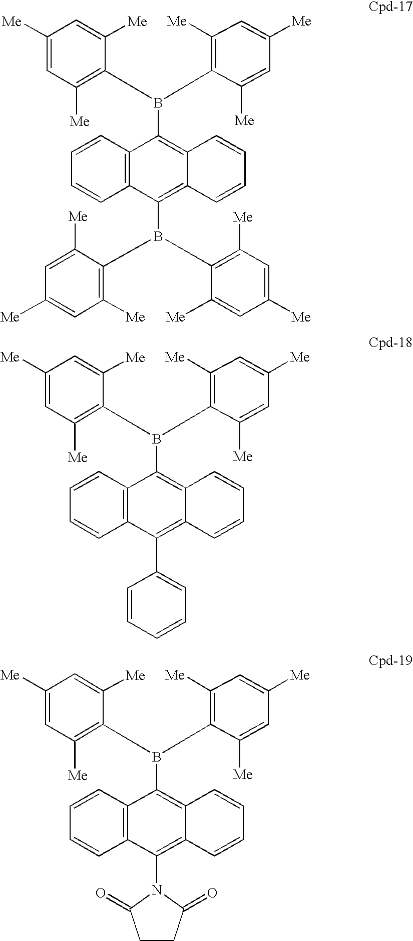

The salt or complex in the electron-transporting layer(s) can be a metal complex represented by Formula (2):

(M)ₘ(Q)ₙ (2)

wherein:

M represents an element selected from Group 1, 2, 12, or 13 of the periodic table,

each Q represents an independently selected ligand; and

m and n are integers selected to provide a neutral charge on the complex (2).

Desirably, M is an alkali or alkaline earth metal, having a work function less than 4.2 eV, wherein the metal has a charge of +1 or +2. Further common embodiments of the invention include those in which there are more than one salt or complex, or a mixture of a salt and a complex in the layer. The salt can be any organic or inorganic salt or oxide of an alkali or alkaline earth metal that can be reduced to the free metal, either as a free entity or a transient species in the device. Examples include, but are not limited to, the alkali and alkaline earth halides, including lithium fluoride (LiF), sodium fluoride (NaF), cesium fluoride (CsF), calcium fluoride (CaF₂) lithium oxide (Li₂O), lithium acetylacetonate (Liacac), lithium benzoate, potassium benzoate, lithium acetate and lithium formate. Examples MC-1-MC-30 are further examples of useful salts or complexes for the invention.

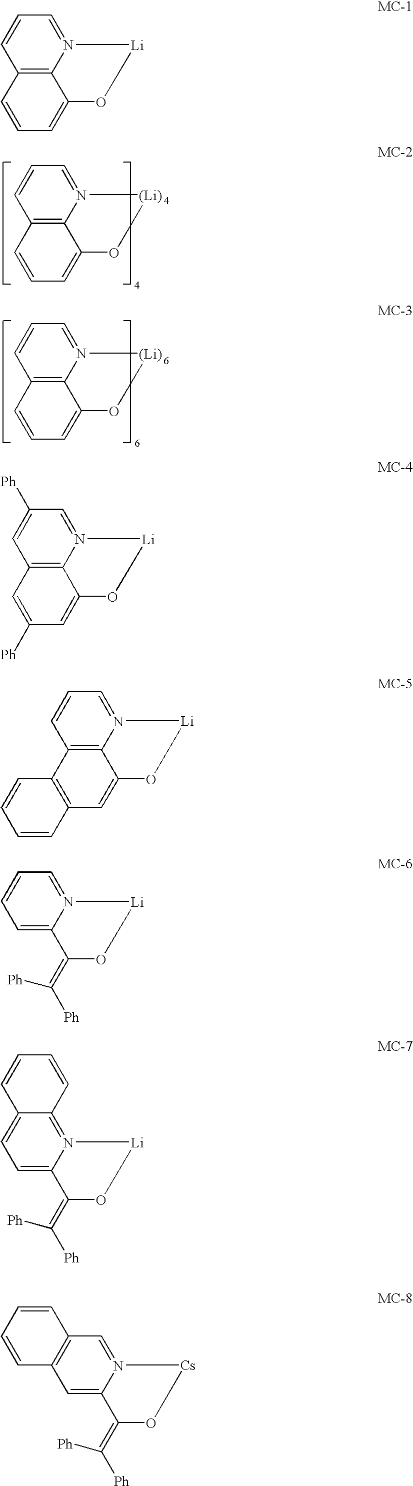

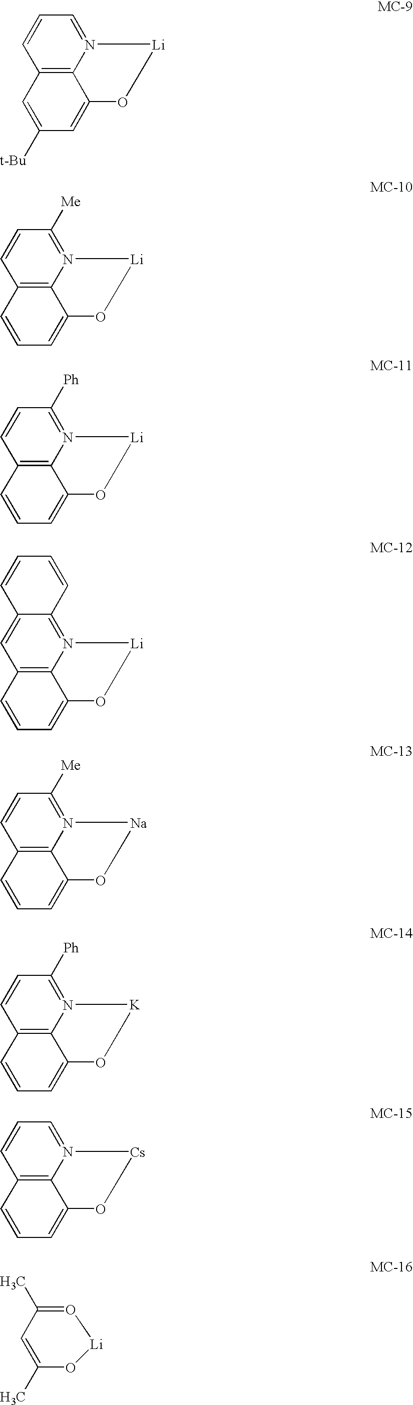

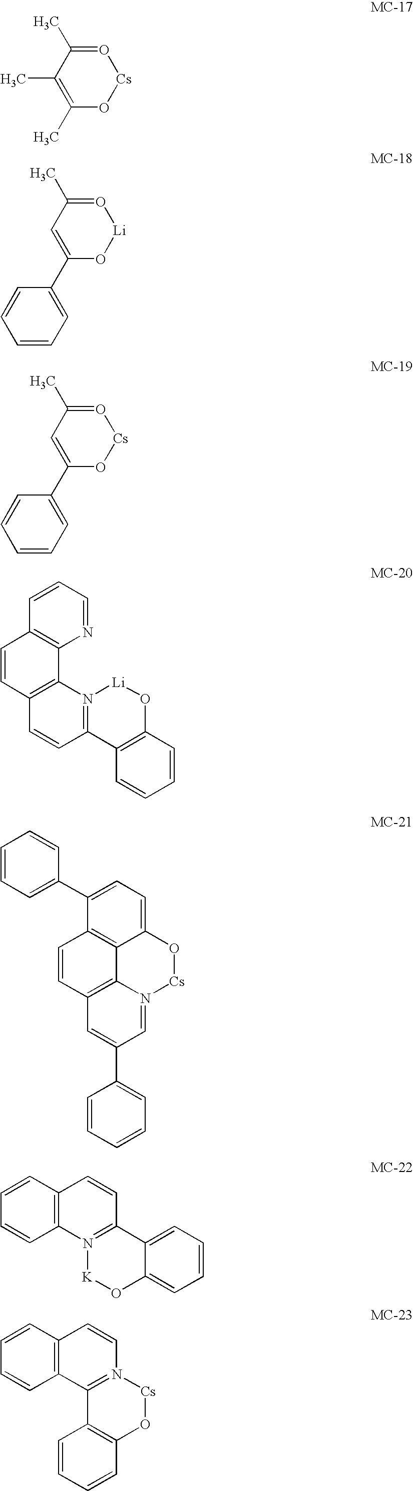

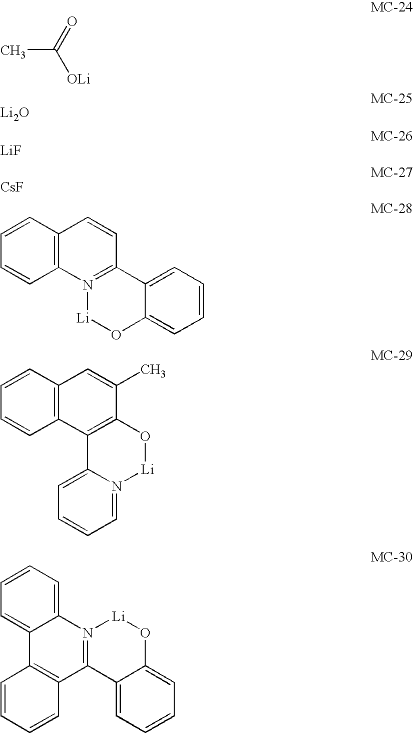

Conveniently, M represents Li⁺ and Q represents an 8-quinolate group, as represented by MC-1 through MC-3.

OLED device layers that can be used in this invention have been well described in the art, and OLED device 10, and other such devices described herein, can include layers commonly used for such devices. OLED devices are commonly formed on a substrate, e.g. OLED substrate 20. Such substrates have been well-described in the art. A bottom electrode is formed over OLED substrate 20 and is most commonly configured as an anode 30, although the practice of this invention is not limited to this configuration. Example conductors for this application include, but are not limited to, gold, iridium, molybdenum, palladium, platinum, aluminum or silver. Desired anode materials can be deposited by any suitable means such as evaporation, sputtering, chemical vapor deposition, or electrochemical means. Anode materials can be patterned using well-known photolithographic processes.

Hole-transporting layer 40 can be formed and disposed over the anode. Desired hole-transporting materials can be deposited by any suitable means such as evaporation, sputtering, chemical vapor deposition, electrochemical means, thermal transfer, or laser thermal transfer from a donor material. Hole-transporting materials useful in hole-transporting layers are well known to include compounds such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen-containing group are disclosed by Brantley et al. in U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural Formula A.

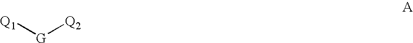

wherein:

Q₁ and Q₂ are independently selected aromatic tertiary amine moieties; and

G is a linking group such as an arylene, cycloalkylene, or alkylene group of a carbon to carbon bond.

In one embodiment, at least one of Q1 or Q2 contains a polycyclic fused ring structure, e.g., a naphthalene. When G is an aryl group, it is conveniently a phenylene, biphenylene, or naphthalene moiety.

A useful class of triarylamines satisfying structural Formula A and containing two triarylamine moieties is represented by structural Formula B.

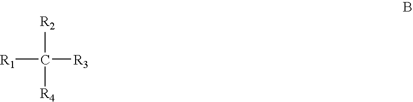

where:

R₁ and R₂ each independently represent a hydrogen atom, an aryl group, or an alkyl group or R₁ and R₂ together represent the atoms completing a cycloalkyl group; and

R₃ and R₄ each independently represent an aryl group, which is in turn substituted with a diaryl substituted amino group, as indicated by structural Formula C.

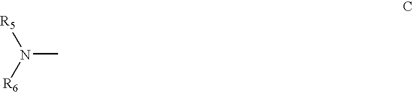

wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by Formula C, linked through an arylene group. Useful tetraaryldiamines include those represented by Formula D.

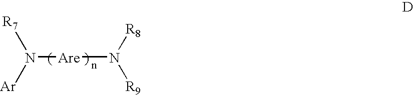

wherein:

each Are is an independently selected arylene group, such as a phenylene or anthracene moiety;

n is an integer of from 1 to 4; and

Ar, R₇, R₈, and R₉ are independently selected aryl groups.

In a typical embodiment, at least one of Ar, R₇, R₈, and R₉ is a polycyclic fused ring structure, e.g., a naphthalene.

The various alkyl, alkylene, aryl, and arylene moieties of the foregoing structural Formulae A, B, C, and D can each in turn be substituted. Typical substituents include alkyl groups, alkoxy groups, aryl groups, aryloxy groups, and halogens such as fluoride, chloride, and bromide. The various alkyl and alkylene moieties typically contain from 1 to about 6 carbon atoms. The cycloalkyl moieties can contain from 3 to about 10 carbon atoms, but typically contain five, six, or seven carbon atoms—e.g., cyclopentyl, cyclohexyl, and cycloheptyl ring structures. The aryl and arylene moieties are usually phenyl and phenylene moieties.

The hole-transporting layer in an OLED device can be formed of a single or a mixture of aromatic tertiary amine compounds. Specifically, one can employ a triarylamine, such as a triarylamine satisfying the Formula B, in combination with a tetraaryldiamine, such as indicated by Formula D. When a triarylamine is employed in combination with a tetraaryldiamine, the latter is positioned as a layer interposed between the triarylamine and the electron-injecting and transporting layer.

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate), also called PEDOT/PSS.

Light-emitting layers produce light in response to hole-electron recombination. The light-emitting layers are commonly disposed over the hole-transporting layer. Desired organic light-emitting materials can be deposited by any suitable means such as evaporation, sputtering, chemical vapor deposition, electrochemical means, or radiation thermal transfer from a donor material. Useful organic light-emitting materials are well known. As are more fully described in U.S. Pat. Nos. 4,769,292 and 5,935,721, the light-emitting layers of the OLED device consist of a luminescent or fluorescent material where electroluminescence is produced as a result of electron-hole pair recombination in this region. The light-emitting layers can include a single material, but more commonly include a host material doped with a guest compound or dopant where light emission comes primarily from the dopant. The dopant is selected to produce color light having a particular spectrum. The host materials in the light-emitting layers can be an electron-transporting material, a hole-transporting material, or another material that supports hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Host and emitting molecules known to be of use include, but are not limited to, those disclosed in U.S. Pat. Nos. 4,768,292; 5,141,671; 5,150,006; 5,151,629; 5,294,870; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline and similar derivatives (Formula E) constitute one class of useful host materials capable of supporting electroluminescence, and are particularly suitable for light emission of wavelengths longer than 500 nm, e.g., green, yellow, orange, and red.

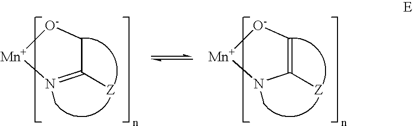

wherein:

M represents a metal;

n is an integer of from 1 to 3; and

Z independently in each occurrence represents the atoms completing a nucleus having at least two fused aromatic rings.

From the foregoing it is apparent that the metal can be a monovalent, divalent, or trivalent metal. The metal can, for example, be an alkali metal, such as lithium, sodium, or potassium; an alkaline earth metal, such as magnesium or calcium; or an earth metal, such as boron or aluminum. Generally any monovalent, divalent, or trivalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Benzazole derivatives constitute another class of useful host materials capable of supporting electroluminescence, and are particularly suitable for light emission of wavelengths longer than 400 nm, e.g., blue, green, yellow, orange or red. An example of a useful benzazole is 2, 2′, 2″-(1,3,5-phenylene)tris[1-phenyl-1H-benzimidazole].

While OLED device 10 is represented with a single light-emitting layer 50, this invention is not limited to that. OLED device 10 can have additional light-emitting layers as well, and it will be understood that light-emitting layer 50 can represent these as well. In one useful embodiment, the at least one light-emitting layer 50 represents one or more layers capable of emitting broadband light, e.g. white light. For example, in one embodiment, OLED device 10 can include a yellow light-emitting layer disposed over hole-transporting layer 40 and doped with a yellow light-emitting compound, and a blue light-emitting layer with a blue light-emitting compound disposed directly on the yellow light-emitting layer.

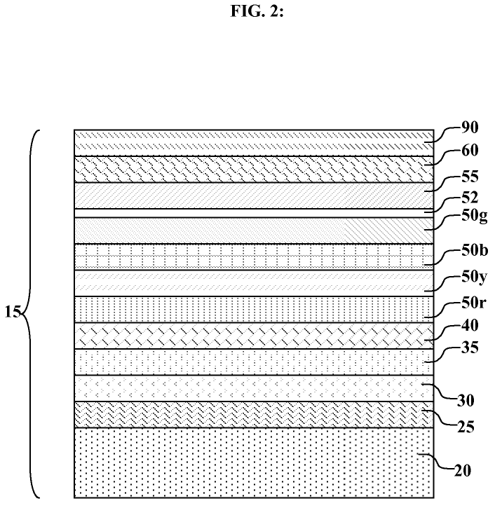

In another useful embodiment, the at least one light-emitting layer 50 represents four different light-emitting layers including a red light-emitting layer with a red light-emitting compound, a yellow light-emitting layer, a blue light-emitting layer, and a green light-emitting layer with a green light-emitting compound, arranged, as taught by Hatwar et al. in U.S. patent application Ser. No. 11/393,767 according to the following criteria: i) each of the light-emitting layers is in contact with at least one other light-emitting layer, ii) the blue light-emitting layer is in contact with the green light-emitting layer, and iii) the red light-emitting layer is in contact with only one other light-emitting layer. In FIG. 2, one such arrangement of the light-emitting layers is shown in OLED device 15. In the arrangement of FIG. 2, red light-emitting layer 50r is formed closest to anode 30, yellow light-emitting layer 50y is in contact with red light-emitting layer 50r, blue light-emitting layer 50b is in contact with yellow light-emitting layer 50y, and green light-emitting layer 50g is in contact with blue light-emitting layer 50b. First electron-transporting layer 52 and second electron-transporting layer 55 are as described above.

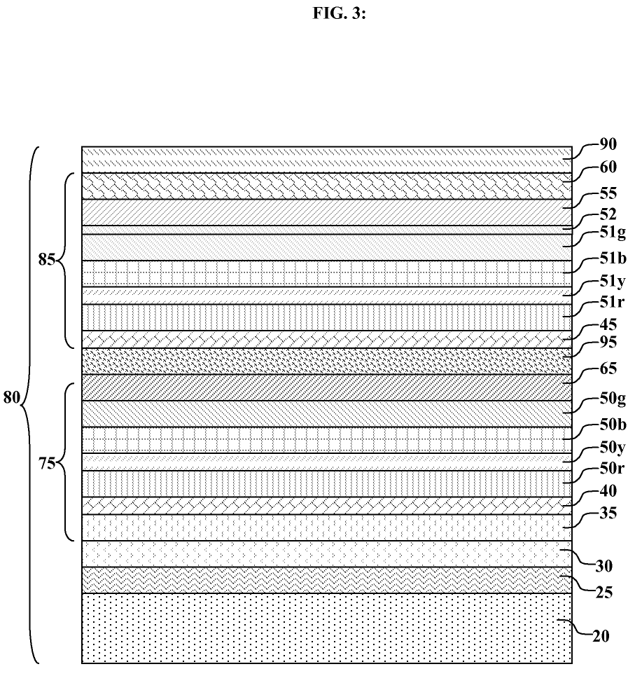

Turning now to FIG. 3, there is shown a cross-sectional view of a pixel of a tandem white-light-emitting OLED device 80 according to another embodiment of the present invention. OLED device 80 includes a substrate 20, a spaced anode 30 and cathode 90, at least two white light-emitting units 75 and 85 disposed between the electrodes, and an intermediate connector 95 disposed between blue and white light-emitting units 75 and 85 respectively. Hatwar et al. in U.S. patent application Ser. No. 11/393,767 has described the use of multiple white light-emitting units of this arrangement. White light-emitting units 75 and 85 each produce emission spectra corresponding to white light. Each white light-emitting unit has four light-emitting layers: a red light-emitting layer (50r and 51r), a yellow light-emitting layer (50y and 51y), a blue light-emitting layer 50b and 51b), and a green light-emitting layer 50g and 51g). The light-emitting layers of white light-emitting units 75 and 85 can have the arrangement according to the criteria described above for OLED device 15. White light-emitting units 75 and 85 can have the same order of light-emitting layers, or can have different orders. Further, the light-emitting layers used can be the same or different (e.g. white light-emitting units 75 and 85 can have red light-emitting layers of the same or different composition, etc.) White light-emitting unit 85 includes first electron-transporting layer 52 and second electron-transporting layer 55, which are as described above, and hole-transporting layer 45. White light-emitting unit 75 includes electron-transporting layer 65.

Tandem OLED device 80 further includes an intermediate connector 95 disposed between white light-emitting units 75 and 85. The intermediate connector provides effective carrier injection into the adjacent EL units. Metals, metal compounds, or other inorganic compounds are effective for carrier injection. However, such materials often have low resistivity, which can result in pixel crosstalk. Also, the optical transparency of the layers constituting the intermediate connector should be as high as possible to permit for radiation produced in the EL units to exit the device. Therefore, it is often preferred to use mainly organic materials in the intermediate connector. Intermediate connector 95 and materials used in its construction have been described in detail by Hatwar et al. in U.S. patent application Ser. No. 11/170,681. Some further nonlimiting examples of intermediate connectors are described in U.S. Pat. Nos. 6,717,358 and 6,872,472, and U.S. Patent Application Publication 2004/0227460 A1.

A red-light-emitting compound can include a diindenoperylene compound of the following structure F:

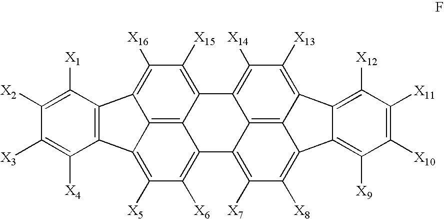

wherein:
X₁-X₁₆ are independently selected as hydrogen or substituents that include alkyl groups of from 1 to 24 carbon atoms; aryl or substituted aryl groups of from 5 to 20 carbon atoms; hydrocarbon groups containing 4 to 24 carbon atoms that complete one or more fused aromatic rings or ring systems; or halogen, provided that the substituents are selected to provide an emission maximum between 560 nm and 640 nm.

Illustrative examples of useful red dopants of this class are shown by Hatwar et al. in U.S. Patent Application Publication 2005/0249972, the disclosure of which is incorporated by reference.

Other red dopants useful in the present invention belong to the DCM class of dyes represented by Formula G:

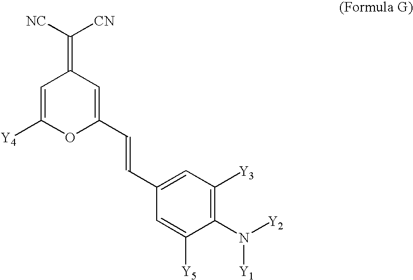

wherein Y₁-Y₅ represent one or more groups independently selected from: hydro, alkyl, substituted alkyl, aryl, or substituted aryl; Y₁-Y₅ independently include acyclic groups or can be joined pairwise to form one or more fused rings; provided that Y₃ and Y₅ do not together form a fused ring.

In a useful and convenient embodiment that provides red luminescence, Y₁-Y₅ are selected independently from: hydro, alkyl and aryl. Structures of particularly useful dopants of the DCM class are shown by Ricks et al. in U.S. Patent Application Publication No. 2005/0181232, the disclosure of which is incorporated by reference.

A light-emitting yellow dopant can include a compound of the following structures:

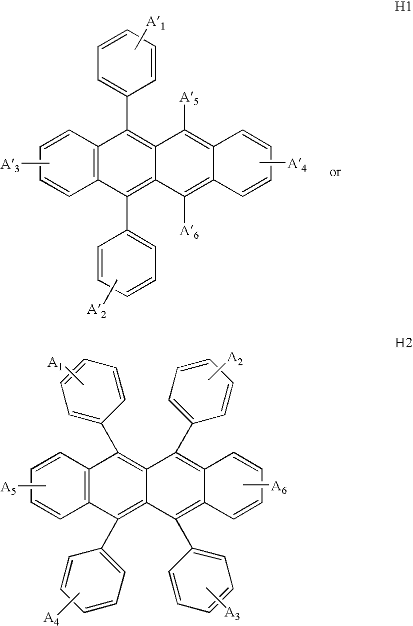

wherein A₁-A₆ and A′₁-A′₆ represent one or more substituents on each ring and where each substituent is individually selected from one of the following:
Category 1: hydrogen, or alkyl of from 1 to 24 carbon atoms;
Category 2: aryl or substituted aryl of from 5 to 20 carbon atoms;
Category 3: hydrocarbon containing 4 to 24 carbon atoms, completing a fused aromatic ring or ring system;
Category 4: heteroaryl or substituted heteroaryl of from 5 to 24 carbon atoms such as thiazolyl, furyl, thienyl, pyridyl, quinolinyl or other heterocyclic systems, which are bonded via a single bond, or complete a fused heteroaromatic ring system;
Category 5: alkoxylamino, alkylamino, or arylamino of from 1 to 24 carbon atoms; or
Category 6: fluoro, chloro, bromo or cyano.

Examples of particularly useful yellow dopants are shown by Ricks et al.

A green-light-emitting compound can include a quinacridone compound of the following structure:

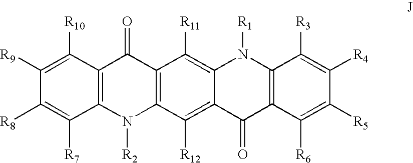

wherein substituent groups R1 and R2 are independently alkyl, alkoxyl, aryl, or heteroaryl; and substituent groups R3 through R12 are independently hydrogen, alkyl, alkoxyl, halogen, aryl, or heteroaryl, and adjacent substituent groups R3 through R10 can optionally be connected to form one or more ring systems, including fused aromatic and fused heteroaromatic rings, provided that the substituents are selected to provide an emission maximum between 510 nm and 540 nm, and a full width at half maximum of 40 nm or less. Alkyl, alkoxyl, aryl, heteroaryl, fused aromatic ring and fused heteroaromatic ring substituent groups can be further substituted. Conveniently, R1 and R2 are aryl, and R2 through R12 are hydrogen, or substituent groups that are more electron withdrawing than methyl. Some examples of useful quinacridones include those disclosed in U.S. Pat. No. 5,593,788 and in U.S. Patent Application Publication 2004/0001969A1.

A green-light-emitting compound can include a coumarin compound of the following structure:

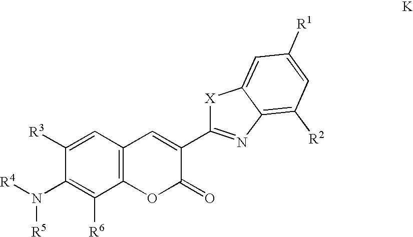

wherein X is O or S; R¹, R², R³ and R⁶ can individually be hydrogen, alkyl, or aryl; R⁴ and R⁵ can individually be alkyl or aryl; or where either R³ and R⁴, or R⁵ and R⁶, or both together represent the atoms completing a cycloalkyl group; provided that the substituents are selected to provide an emission maximum between 510 nm and 540 nm, and a full width at half maximum of 40 nm or less.

Examples of useful green dopants are disclosed by Hatwar et al. in U.S. Patent Application Publication 2005/0249972.

A blue-light-emitting dopant can include perylene or derivatives thereof, or a bis(azinyl)azene boron complex compound of the structure L:

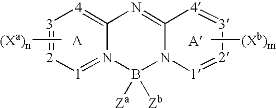

wherein:
A and A′ represent independent azine ring systems corresponding to 6-membered aromatic ring systems containing at least one nitrogen;
(X^{a})ₙ and (X^{b})ₘ represent one or more independently selected substituents and include acyclic substituents or are joined to form a ring fused to A or A′;
m and n are independently 0 to 4;
Z^{a} and Z^{b} are independently selected substituents;
1, 2, 3, 4, 1′, 2′, 3′, and 4′ are independently selected as either carbon or nitrogen atoms; and
provided that X^{a}, X^{b}, Z^{a}, and Z^{b}, 1, 2, 3, 4, 1′, 2′, 3′, and 4′ are selected to provide blue luminescence.

Some examples of the above class of dopants are disclosed by Ricks et al U.S. Patent Application Publication 2005/0181232.

Particularly useful blue dopants of the perylene class include perylene and tetra-t-butylperylene (TBP).

Another particularly useful class of blue dopants in this invention includes blue-emitting derivatives of such distyrylarenes as distyrylbenzene and distyrylbiphenyl, including compounds described in U.S. Pat. No. 5,121,029. Among derivatives of distyrylarenes that provide blue luminescence, particularly useful are those substituted with diarylamino groups, also known as distyrylamines. Examples include bis[2-[4-[N,N-diarylamino]phenyl]vinyl]-benzenes of the general structure M1 shown below:

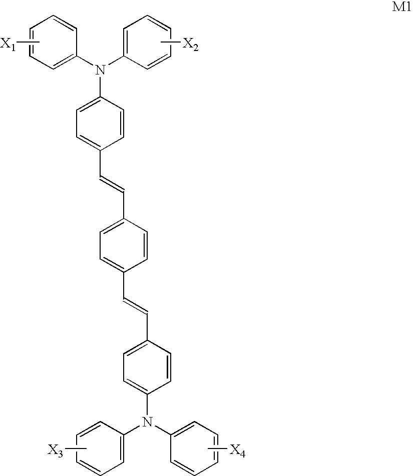

and bis[2-[4-[N,N-diarylamino]phenyl]vinyl]biphenyls of the general structure M2 shown below:

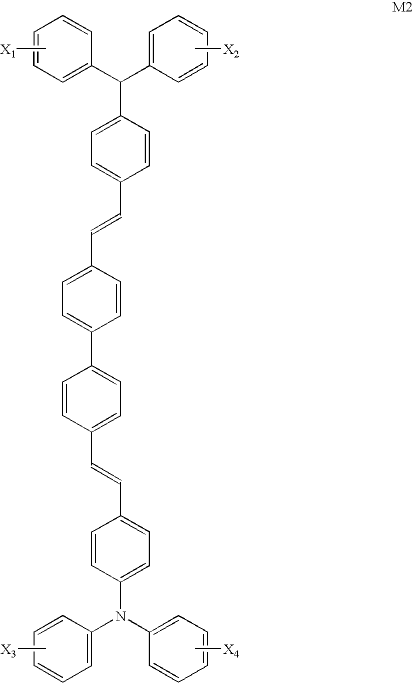

In Formulas M1 and M2, X₁-X₄ can be the same or different, and individually represent one or more substituents such as alkyl, aryl, fused aryl, halo, or cyano. In a preferred embodiment, X₁-X₄ are individually alkyl groups, each containing from one to about ten carbon atoms. A particularly preferred blue dopant of this class is disclosed by Ricks et al U.S. Patent Application Publication 2005/0181232.

An upper electrode most commonly configured as a cathode 90 is formed over the electron-transporting layer. If the device is top-emitting, the electrode must be transparent or nearly transparent. For such applications, metals must be thin (preferably less than 25 nm) or one must use transparent conductive oxides (e.g. indium-tin oxide, indium-zinc oxide), or a combination of these materials. Optically transparent cathodes have been described in more detail in U.S. Pat. No. 5,776,623. Cathode materials can be deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

OLED device 10 can include other layers as well. For example, a hole-injecting layer 35 can be formed over the anode, as described in U.S. Pat. Nos. 4,720,432;. 6,208,075 and EP 0 891 121 A1, and EP 1 029 909 A1. An electron-injecting layer 60, such as alkaline or alkaline earth metals, alkali halide salts, or alkaline or alkaline earth metal doped organic layers, can also be present between the cathode and the electron-transporting layer. White light-emitting OLED devices can include one or more color filters 25, which have been well-described in the art.

The invention and its advantages can be better appreciated by the following comparative examples. The layers described as vacuum-deposited were deposited by evaporation from heated boats under a vacuum of approximately 10-6 Torr. After deposition of the OLED layers each device was then transferred to a dry box for encapsulation. The OLED has an emission area of 10 mm². The devices were tested by applying a current of 20 mA/cm² across electrodes, except for operational fade, which was tested at 80 mA/cm². The performance of the devices is given in Table 1.

### EXAMPLE 1 (COMPARATIVE)

A comparative color OLED display was constructed in the following manner:
1. A clean glass substrate was deposited by sputtering with indium tin oxide (ITO) to form a transparent electrode of 60 nm thickness.
2. The above-prepared ITO surface was treated with a plasma oxygen etch.
3. The above-prepared substrate was further treated by vacuum-depositing a 10 nm layer of hexacyanohexaazatriphenylene (CHATP) as a hole-injecting layer (HIL).

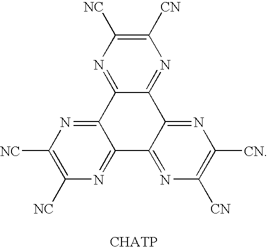

4. The above-prepared substrate was further treated by vacuum-depositing a 10 nm layer of 4,4′-bis[N-(1-naphthyl)-N-phenylamino]biphenyl (NPB) as a hole-transporting layer (HTL).
5. The above-prepared substrate was further treated by vacuum-depositing a 20 nm yellow light-emitting layer including 13.6 nm NPB (as host) and 6 nm 9,10-bis(2-naphthyl)anthracene (ADN) as a stabilizer with 2% yellow-orange emitting dopant diphenyltetra-t-butylrubrene (PTBR).

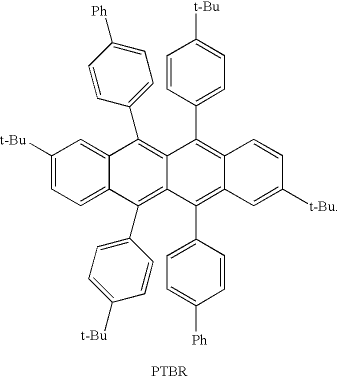

6. The above-prepared substrate was further treated by vacuum-depositing a 20 nm blue light-emitting layer including 18.4 nm 9-(2-naphthyl)-10-(4-biphenyl)anthracene (BNA) host and 1.4 nm NPB cohost with 1% BEP as blue-emitting dopant.

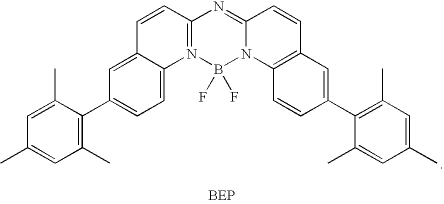

7. A 40 nm mixed electron-transporting layer was vacuum-deposited, including 10 nm BNA and 30 nm lithium quinolate (LiQ).
8. A 100 nm layer of aluminum was evaporatively deposited onto the substrate to form a cathode layer.

### EXAMPLE 2 (COMPARATIVE)

A comparative color OLED display was constructed as in Example 1, except that Step 7 was as follows:
7. A 40 nm mixed electron-transporting layer was vacuum-deposited, including 10 nm BNA, 30 nm LiQ, and doped with 1% Li metal.

### EXAMPLE 3 (COMPARATIVE)

An inventive color OLED display was constructed as in Example 1, except that Steps 7 and 8 were replaced with the following steps:
7. A 3 nm layer of LiQ was vacuum-deposited.
8. A 40 nm mixed electron-transporting layer was vacuum-deposited, including 10 nm BNA, 30 nm LiQ, and doped with 1% Li metal.
9. A 100 nm layer of aluminum was evaporatively deposited onto the substrate to form a cathode layer.

### EXAMPLE 4 (INVENTIVE)

An inventive color OLED display was constructed as in Example 3, except that Step 7 was as follows:
7. A 3 nm mixed electron-transporting layer was vacuum-deposited, including 1.5 nm BNA and 1.5 nm LiQ.

### EXAMPLE 5 (INVENTIVE)

An inventive color OLED display was constructed as in Example 3, except that Step 7 was as follows:
7. A 3 nm layer of BNA was vacuum-deposited.

The results of testing these examples are shown in Table 1, below. Example 1 shows the results for an OLED device known in the art. Example 2 demonstrates the addition of dopant lithium to the electron-transporting layer, with a strong decrease in luminance efficiency and fade stability. The addition of a thin lithium-free electron-transporting layer comprising lithium quinolate between the standard electron-transporting layer and the emitting layers, as in Example 3, gives improved luminance efficiency and lower drive voltage, but the fade stability is still poor. However, the use of an anthracene in the thin electron-transporting layer, as in Examples 4 and 5, gives good stability while retaining good drive voltage and luminance efficiency.

TABLE 1
Device data measured at 20 mA/cm² (except as noted)

| | | | | | | Room Temp |
|---|---|---|---|---|---|---|
| | | | | | | Fade Stability |
| | | | Lum Efficiency | | | @80 mA/cm² |
| Device # | | Voltage | (cd/A) | CIEx | CIEy | (hrs to 50%) |
| Example 1 | Undoped ETL | 5.2 | 9.5 | 0.31 | 0.31 | 500 |
| (Comparative) | | | | | | |
| Example 2 | Li-doped ETL | 5.0 | 2.3 | 0.27 | 0.31 | 268 |
| (Comparative) | | | | | | |
| Example 3 | LiQ 2nd ETL | 3.6 | 12.7 | 0.35 | 0.35 | 200 |
| (Comparative) | | | | | | |
| Example 4 | Mixed 2nd | 3.4 | 12.9 | 0.36 | 0.36 | 400 |
| (Inventive) | ETL | | | | | |
| Example 5 | BNA 2nd | 3.2 | 12.8 | 0.37 | 0.37 | 400 |
| (Inventive) | ETL | | | | | |

The invention has been described in detail with particular reference to certain preferred embodiments thereof, but it will be understood that variations and modifications can be effected within the spirit and scope of the invention.

### PARTS LIST

10 OLED device
15 OLED device
20 substrate
25 color filter
30 anode
35 hole-injecting layer
40 hole-transporting layer
45 hole-transporting layer
50 light-emitting layer
50r red light-emitting layer
50y yellow light-emitting layer
50b blue light-emitting layer
50g green light-emitting layer
51r red light-emitting layer
51y yellow light-emitting layer
51b blue light-emitting layer
51g green light-emitting layer
52 electron-transporting layer
55 electron-transporting layer
60 electron-injecting layer
65 electron-transporting layer
75 white light-emitting unit
80 OLED device
85 white light-emitting unit
90 cathode
95 intermediate connector

1. An OLED device comprising:
(a) an anode and a cathode spaced apart; and
(b) at least one light-emitting layer, and a hole-transporting layer disposed between the anode and the light-emitting layer; and
(c) a first electron-transporting layer in contact with at least one light-emitting layer and a second electron-transporting layer in contact with the first electron-transporting layer, wherein the first and second electron-transporting layers are disposed between the at least one light-emitting layer and the cathode, wherein:
(i) the first electron-transporting layer contains an anthracene compound of Formula (1); 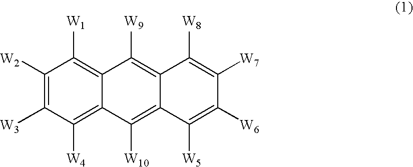
wherein W₁-W₁₀ independently represent hydrogen or an independently selected substituent, and
(ii) the second electron-transporting layer contains an anthracene compound of Formula (1) and at least one salt or complex of an element selected from Group 1, 2, 12 or 13 of the Periodic Table, and is further doped with an alkali metal.

2. The OLED device of claim 1 wherein the first electron-transporting layer has a thickness in a range of 1 to 20 nm.

3. The OLED device of claim 2 wherein the first electron-transporting layer has a thickness in a range of 2 to 5 nm.

4. The OLED device of claim 1 wherein the second electron-transporting layer has a thickness in a range of 10 to 200 nm.

5. The OLED device of claim 1 wherein the at least one light-emitting layer emits white light.

6. The OLED device of claim 5 including a yellow light-emitting layer and a blue light-emitting layer disposed directly on the yellow light-emitting layer.

7. The OLED device of claim 1 further including an electron-injecting layer.

8. The OLED device of claim 1 wherein the anthracene compound in the first electron-transporting layer and the anthracene compound in the second electron-transporting layer are the same.

9. The OLED device of claim 1 wherein the anthracene compound in the first electron-transporting layer and the anthracene compound in the second electron-transporting layer are different.

10. The OLED device of claim 1 wherein W₉ and W₁₀ are independently selected from phenyl, biphenyl, naphthyl or anthracenyl groups, and W₁-W₈ are independently selected from hydrogen, alkyl or phenyl groups.

11. The OLED device of claim 1 wherein the anthracene compounds in both the first electron-transporting layer and the second electron-transporting layer are selected from:

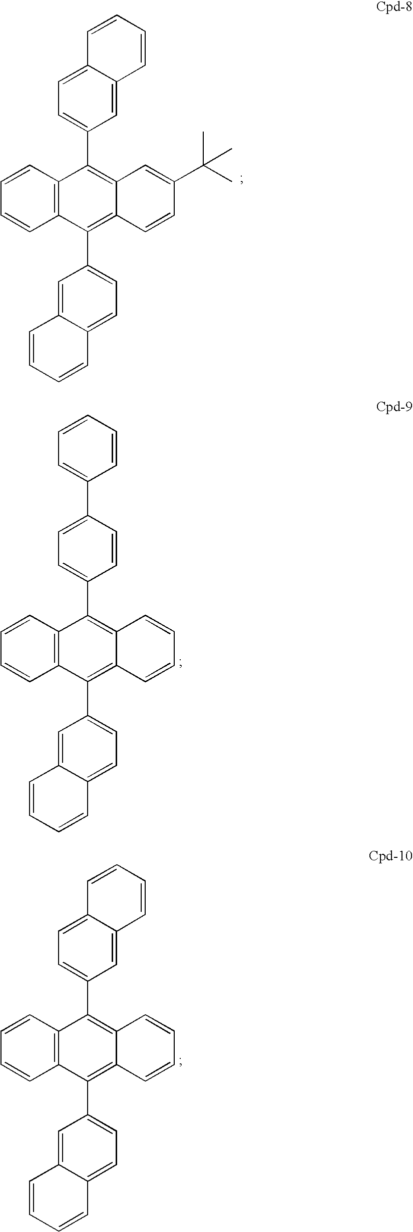

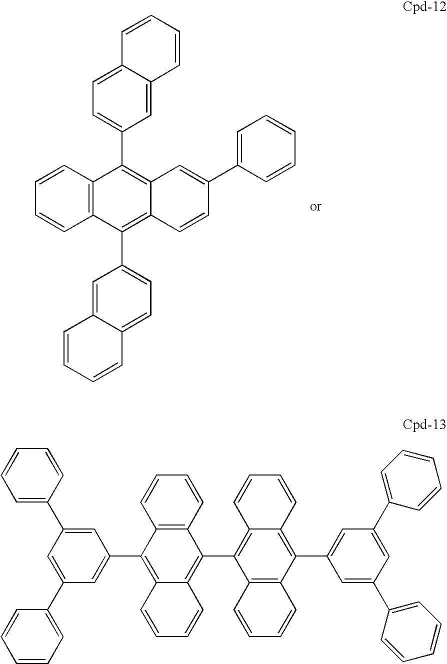

12. The OLED device of claim 1 wherein the anthracene compound in the first electron-transporting layer comprises greater than 10% of the layer by volume.

13. The OLED device of claim 1 wherein the anthracene compound in the second electron-transporting layer comprises from 10% to 90% of the layer by volume.

14. The OLED device of claim 1 wherein the salt or complex is a metal complex represented by Formula (2):
(M)ₘ(Q)ₙ (2)
wherein:
M represents an alkali or alkaline earth metal,
each Q represents an independently selected ligand; and
m and n are integers selected to provide a neutral charge on the complex (2).

15. The OLED device of claim 14 wherein M represents Li+ and Q represents an 8-quinolate group.

16. The OLED device of claim 1 wherein the salt or complex comprises 20-60% of the layer by volume.

17. The OLED device of claim 1 wherein the alkali metal is lithium.

18. The OLED device of claim 17 wherein lithium is present in the amount of from 0.1% to 10% by volume of the total material in the layer.

19. The OLED device of claim 1 wherein the first electron-transporting layer further includes at least one salt or complex of an element selected from Group 1, 2, 12 or 13 of the Periodic Table.

20. The OLED device of claim 1 including a red light-emitting layer, a yellow light-emitting layer, a blue light-emitting layer, and a green light-emitting layer, arranged such that each of the light-emitting layers is in contact with at least one other light-emitting layer, the blue light-emitting layer is in contact with the green light-emitting layer, and the red light-emitting layer is in contact with only one other light-emitting layer.

21. The OLED device of claim 1 including at least two white light-emitting units that are disposed between the electrodes and that produce emission spectra corresponding to white light and each white light-emitting unit having four light-emitting layers including a red light-emitting layer, a yellow light-emitting layer, a blue light-emitting layer, and a green light-emitting layer, arranged such that each of the light-emitting layers of a white light-emitting unit is in contact with at least one other light-emitting layer of that unit, the blue light-emitting layer of a white light-emitting unit is in contact with the green light-emitting layer of that unit, and the red light-emitting layer of a white light-emitting unit is in contact with only one other light-emitting layer of that unit, and with an intermediate connector disposed between the white light-emitting units.
